(19) United States
(12) Patent Application Publication
(10) Pub. No.: US 2009/0280217 A1
(43) Pub. Date: Nov. 12, 2009

(54) Method for Production of Soybean Peptide Mixture

(76) Inventors: Mitsuru Katase, Izumisano-shi (JP); Toshihiro Nakamori, Tsukubamirai-shi (JP); Xinqi Liu, Izumisano-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/086,017

(22) PCT Filed: Dec. 6, 2006
(86) PCT No.: PCT/JP2006/324372

§ 371 Date: Jun. 4, 2008

(30) Foreign Application Priority Data
Dec. 6, 2005 (JP) 2005-352603

(51) Int. Cl. A23J 3/34; A23J 3/16

(52) U.S. Cl. 426/63

(57) ABSTRACT

The object is to provide a soybean protein hydrolyzate which can be produced by hydrolysis of a soybean protein produced by “method B” as defined in the description and produces no dreg even when refrigerated under acidic conditions, particularly a soybean peptide mixture having a relatively low molecular weight. Disclosed is a method for production of a soybean peptide mixture, comprising the steps of: (a) extracting a concentrated soybean protein with water to yield an extract; (b) treating the extract with a protease under alkaline to neutral conditions; (c) further treating the resulting product with a protease under acidic conditions; (d) treating the resulting product with a phytic acid (phytase)-decomposing enzyme; and (e) separating and removing an insoluble material from the product.

### TECHNICAL FIELD

The present invention is to provide a soybean peptide mixture free from the formation of dregs even in an acid aqueous system. More specifically, the present invention provides a soybean peptide mixture free from the formation of dregs even when it is refrigerated and stored in an acid aqueous system.

### BACKGROUND ART

Hitherto, in general, soybean protein isolates have been produced by the following methods, and these methods are main methods for the industrial production of soybean proteins.

Water is added to defatted soybeans to prepare an aqueous slurry from which “okara (soy pulp)” is separated and removed by, for example, centrifugation, and an acid is added to the resulting water soluble fraction (defatted soybean milk) to adjust its pH to the isoelectric point of a soybean protein to precipitate a soybean protein and to separate and remove the supernatant (soybean whey), thereby obtaining an acidic slurry. This acid slurry is neutralized by addition of an alkali, and dried by spray drying etc. to obtain a so-called “separated soybean isolate” (hereinafter referred to as method A).

On the other hand, there is a method wherein a soybean protein solution obtained by extracting a soybean protein concentrate with water to remove “okara” is spray-dried to obtain a soybean protein isolate (hereinafter referred to as method B).

As a soybean protein concentrate, there are an alcohol concentrate which is obtained by separating and removing a whey component or the like from defatted soybeans with an alcohol solution, and an acid concentrate which is obtained by preparing a slurry directly from defatted soybeans in an acid aqueous system, and removing the supernatant, i.e., whey of supernatant is removed to obtain an acid slurry, followed by drying, etc.

In the case of an alcohol concentrate, a soybean protein isolate can be obtained by adding water to the concentrate, and removing “okara”, followed by spray-drying, etc.

In the case of an acid concentrated, a soybean protein isolate can be obtained by neutralizing its slurry, and removing “okara” to obtain a solution of a soybean protein isolate, followed by spray-drying, etc.

The soybean protein prepared by the latter method (method B) has a good taste as compared with that prepared by the former method (method A), and a soybean protein hydrolyzate obtained by hydrolysis of this soybean protein has also a good taste.

However, according to the present inventors' study, when used in an acidic food and drink such as an acidic drink, it has been revealed that a soybean protein hydrolyzate of a soybean protein prepared by method B has a problem that it tends to form dregs as compared with a hydrolyzate of a soybean protein prepared by method A.

That is, regarding a soybean protein hydrolyzate obtained by treating a solution of a soybean protein isolate with a protease, the hydrolyzate obtained by using a soybean protein prepared by method A hardly forms dregs (white turbidity) even when refrigerated under acidic conditions, while the hydrolyzate obtained by using a soybean protein prepared by method B had a problem that it easily forms dregs when refrigerated under acidic conditions.

Since a soybean protein has an isoelectric point around pH 4.5, formation of dregs can be avoided by using the hydrolyzate in a somewhat weak acidic drink rather than in an acidic drink. For example, as a known method, Patent Document 1 discloses that a pH of a drink is adjusted to as high range as about 6. However, such pH is too high to produce an acidic drink with pH 3 to 4.5.

Hitherto, various inventions have been made so as to produce a soybean protein hydrolyzate which is free from the formation of dregs (white turbidity) even under an acid aqueous system such as use in as acidic drinks. Patent Document 2 discloses a method for production of a soluble soybean protein which is soluble in acidic to alkaline regions, wherein a soybean protein obtained by method A is treated with an endo-/exo-protease followed by centrifugation, etc. However, there are unpleasant odors and bad tastes such as astringency, and the taste and flavor are thus undesirable.

The present applicant discloses, in Patent Document 3, a soluble soybean protein at pH of 3.0 to 4.5 capable of using it in acidic foods of pH of lower than 4.6. This invention is characterized in that a solution containing a soybean protein is heat-treated at a temperature exceeding 100° C. under acidic conditions after polyanion substances in the solution are removed or inactivated, and/or polycation substances are added thereto.

In addition, this document also discloses the elimination of phytic acid and the treatment with phytase as the above treatment that the polyanion substances are removed or inactivated. Further, this document also discloses to carry out a hydrolysis treatment of a protein with a protease.

However, while the resulting soybean protein exhibits excellent solubility and storage stability in an acidic region, it is a soybean protein having functional characteristics such as emulsifying capability and gel formation capability, and is not a soybean peptide mixture having such low molecular weight as the present invention. Further, there is no teaching of a two-step enzymatic decomposition treatment as in the present invention.

Patent Document 4 discloses a method for enhancing solubility of a protein in an acidic region below an isoelectric point, wherein a slurry of a soybean protein isolate having pH about 2.0 to 4.2 and a solid content of 10 to 15% by weight is prepared and the slurry is subjected to heat treatment in a continuous system at a temperature of about 120 to 160° C.

However, this is a soybean protein, and is not a hydrolyzed soybean peptide mixture having low molecular weight as in the present invention. In addition, it forms dregs during storage when it is used in an acidic drink.

Patent Document 5 discloses a method for isolating a soluble protein fraction which is soluble at pH 4.6 or lower, wherein phytase treatment is combined with fractionation by pH adjustment. However, a yield of this method is as low as 14% based on a raw material of a soybean protein isolate and is unsuitable for practical use. Further, it does not teach a two-step enzymatic decomposition treatment as in the present invention.

The present applicant has disclosed, in Patent Document 6, a method for production of a soybean protein hydrolyzate which does not form dregs even in an acidic region, wherein a soybean protein obtained by method A is subjected to protease treatment.

This method is characterized by heat treatment, and the hydrolyzate does not form dregs even in an acidic region. However, the product has unpleasant odors and bad tastes such as astringency, and the taste and flavor are thus undesirable.

Further, the present applicant has disclosed, in Patent Document 7, a method for treatment of a soybean protein, wherein the soybean protein is subjected to protease treatment, and then subjected to phytase treatment.

However, the raw material is a soybean protein obtained by method A, and the purpose of treatment is to reduce or remove phytic acid contained in the soybean protein. Therefore, this method does not teach a two-step enzymatic decomposition.

As an example using a soybean protein obtained by method B, Patent Document 8 discloses a method for production of a protein having excellent solubility at pH 3 to 5, wherein acid-washed defatted soybeans are treated with acidic phytase of microbial origin at pH 2 to 6, followed by fractionation of a solubilized fraction. In addition, this document also discloses that an acid slurry is subjected to protease treatment at the same time or after phytase treatment.

In this invention, phytase treatment aims to enhance a protein extraction efficiency under acidic conditions, and protease treatment aims to further improve tastes. Therefore, the object and process of this invention are different from those of the present invention. In addition, it does not teach a two-step protease treatment. Further, when intensive hydrolysis with a protease under acidic conditions is performed, astringency and delicious tastes are generated. This is undesirable.
Patent Document 1: JP 2002-10764 A
Patent Document 2: JP 2005-80668 A
Patent Document 3: WO 2002/067690
Patent Document 4: JP 53-19669 A
Patent Document 5: JP 55-29654 A
Patent Document 6: JP 2001-238693 A
Patent Document 7: WO 2004/17751
Patent Document 8: JP 51-125300 A

### DISCLOSURE OF THE INVENTION

### Problem to be Solved by the Invention

As described above, although a soybean peptide mixture obtained by hydrolysis of a soybean protein prepared by method B is superior in taste and flavor to those of a mixture of a soybean protein prepared by method A, the mixture has such a drawback that it tends to form dregs in an acid aqueous system, in particular, under refrigeration.

Then, an object of the present invention is to provide a soybean protein hydrolyzate, in particular, a soybean peptide mixture having relatively low molecular weight, which is free from dreg formation even when refrigerated under acidic conditions, by using a soybean protein prepared by method B as a raw material.

### Means for Solving the Problem

The present inventors have intensively studied enzymatic decomposition methods of a soybean protein obtained by method B, and have found that, when a soybean protein is hydrolyzed with an endoprotease under alkaline to neutral conditions, and the resulting hydrolyzate is treated with a protease having an exo-activity under acidic conditions, and then further treated with phytase, the resulting soybean protein hydrolyzate does not form dregs even in an acid aqueous system.

Further, the present inventors have studies enzymes to be used under acidic conditions, and have found that a proteolytic enzyme of genus Rhizopus origin exhibits a remarkable effect and a proteolytic enzyme of genus Aspergillus origin also exhibits a certain degree of effect. Thus, the present invention has been completed.

That is, the present invention provides a soybean peptide mixture obtained by subjecting a soybean protein obtained by this method B to a two-step enzymatic hydrolysis, and they treating with a phytase, which has excellent taste and is free from the formation of dregs even in an acid aqueous system in a refrigerated state. Specifically, the present invention is a method for production of a soybean peptide mixture comprising the steps of: (a) extracting a concentrated soybean protein with water to obtain an extract; (b) treating the extract with a protease under alkaline to neutral conditions; (c) further treating the resulting product with a protease under acidic conditions; (d) treating the resulting product with a phytic acid-decomposing enzyme; and (e) separating and removing an insoluble matter from the product. Preferably, the enzyme used in (b) step comprises an endo-type. The hydrolysis degree in (b) step is preferably 20 to 98% of a soybean protein decomposition rate in terms of a 15% trichloroacetic acid soluble rate of protein components. Preferably, the enzyme used in (c) step comprises an exo-type. The enzyme used in (c) step is preferably an enzyme of genus Aspergillus or Rhizopus origin. Preferably, (d) step is performed after (c) step or simultaneously. Average molecular weight of the soybean protein mixture is preferably 200 to 5000.

### Effect of the Invention

The present invention makes it possible to produce a soybean peptide mixture which not only has excellent taste superior to that obtained by treating a soybean protein with a protease according to a conventional method A, but also is free from formation of dregs even when refrigerated in an acid aqueous system.

Thus, it is possible to provide a soybean peptide mixture having excellent taste to be used in an acidic food and drink such as an acidic drink and an acidic jelly.

### BEST MODE FOR CARRYING OUT THE INVENTION

The present invention is a method for production of a soybean peptide mixture comprising the steps of: (a) extracting a concentrated soybean protein with water to obtain an extract; (b) treating the extract with a protease under alkaline to neutral conditions; (c) further treating the resulting product with a protease under acidic conditions; (d) treating the resulting product with a phytic acid-decomposing enzyme; and (e) separating and removing an insoluble matter from the product.

That is, the present invention is characterized by using (a) and the essential constitutive features of the steps (b) to (e).

An alcohol concentrate or an acid concentrate as described in the above Background Art can be used as the concentrated soybean protein in (a) step.

Examples of the concentrated soybean protein include an alcohol concentrate obtained by separating and removing whey components, etc. from defatted soybeans using an alcoholic solution, and an acid concentrate (acidic concentrated soybean protein) obtained by preparing a slurry of defatted soybeans in an acid aqueous system directly, removing the supernatant, i.e., whey, and drying the resulting acidic slurry.

Therefore, the extract of a concentrated soybean protein with water can be obtained in such a manner that water is added to an alcohol concentrate, followed by removing “okara” from the resulting slurry, or an acid concentrate is neutralized, followed by removing “okara”. For example, the extract of a concentrated soybean protein with water in (a) step can be obtained according to a method described in WO 2004/013170 filed by the present applicant.

Next, (b) step of treating the extract with a protease under alkaline to neutral conditions will be illustrated.

The present invention is characterized by combination of (c) step and (d) step after (b) step.

Although the reason is unknown, when (a) is used as a raw material, it is very difficult to obtain a soybean protein hydrolyzate which is free from dreg formation in an acid aqueous system only by carrying out (b) step of protease treatment under alkaline to neutral conditions.

In (b) step of the present invention, it is proper to carry out the protease treatment under alkaline to neutral conditions.

Although the reason is unknown, it is assumed that a soybean protein whose conformation would be relaxed and become a loose state under alkaline to very weak alkaline is hydrolyzed with an endoprotease, and then is subjected to hydrolysis under acidic conditions, thereby resulting in certain effects.

Therefore, an enzyme having an active pH in alkaline to neutral regions is suitable, and an enzyme having an optimum pH in alkaline to neutral regions is preferable.

As the enzymatic decomposition proceeds, pH of a reaction mixture shifts to an acid side. However, in the present invention, it is sufficient that pH at the beginning of the enzymatic decomposition reaction is in alkaline to neutral region. Preferably, pH at the beginning of the enzymatic decomposition reaction is pH 7 to 9 because the formation of a salt due to neutralization can be reduced.

Since other hydrolysis conditions (temperature, E/S ratio, etc.) are varied depending on a particular kind of a proteolytic enzyme to be used, the amount of the enzyme to be added and the reaction time can be determined so that the desired decomposition rate can be obtained.

Since the enzyme used in (b) step of the present invention gives a sense of incongruity because it produces delicious and amino-acid tastes which are unsuitable for beverage uses, it is preferable to contain an endo-type, i.e., a so-called endoprotease so as to reduce such tastes. Usually, it is suitable that a free amino acid content in a dry solid matter of an enzymatic decomposition product after the protease treatment is within 10%, preferably within 5%.

The enzyme may be that of any origin regardless of animal, plant or microbial origin. Specific examples thereof include a serine protease (trypsin and chymotrypsin of animal origin, subtilisin of microbial origin, etc.), and a thiol protease (papain, ficin, bromeline of plant origin, etc.). More specifically, examples thereof include “Alkalase” of Bacillus licheniformes origin (manufactured by Novozymes Japan Ltd.), “Protease S” of Bacillus subtilis origin (manufactured by Amano Enzyme Inc.), “Bioplase SP-15FG” (manufactured by Nagase Chemtex Corporation), “Protin AY40” (manufactured by Daiwa Kasei Co., Ltd.), “Protin AC-10” (manufactured by Daiwa Kasei Co., Ltd.), “Protin NY50” (manufactured by Daiwa Kasei Co., Ltd.), and the like.

These enzymes have an active pH in alkaline to neutral regions with an optimum pH in a very weak alkaline to alkaline regions except for Protin NY50 which has an optimum pH in a neutral range. These enzymes can be used alone or in combination of 2 or more kinds thereof.

The protein concentration of a soybean protein solution in the protease treatment is 1 to 30% by weight, preferably 5 to 15% by weight, more preferably, 8 to 12% by weight is suitable. The protein concentration can be adjusted in this range by suitably selecting extraction conditions such as extraction pH, extraction temperature, extraction time, extract amount, the number of extraction, and the like. Even when the concentration is too low, the protease treatment is not disturbed. However, productivity is bad, and production costs of soybean protein hydrolyzate are therefore increased. Further, when the concentration of a soybean protein solution is too high, a large amount of enzyme is required for sufficient progress of the reaction.

The degree of hydrolysis by the protease treatment in (b) step is usually 20 to 98%, more suitably 50 to 90% as a soybean protein decomposition rate in terms of a 15% trichloroacetic acid soluble rate of protein components. The time required for reacting a proteolytic enzyme varies depending on the activity of proteolytic enzyme to be used and its amount. However, usually, it is about 30 minutes to 24 hours, preferably about 1 hour to 4 hours. Too long enzymatic decomposition time tends to cause spoilage.

Next, (c) step of the protease treatment under acidic conditions will be illustrated.

This protease treatment under acidic conditions aims to precipitate dregs by combination with next (d) step, it is not necessary to highly hydrolyze under acidic conditions.

The (c) step of the present invention is characterized by the protease treatment performed under acidic conditions. In addition, it is a mild hydrolysis to prevent dreg formation, the degree thereof is preferably suppressed within the above-mentioned range even if free amino acids increase as described above, or even if average molecular weight decreases. Preferred conditions of (c) step are as follows.

The pH of this acidic range is suitably pH 3 to 6.2, preferably, pH 4 to 5.5. It is difficult to obtain a target soybean peptide mixture in alkaline conditions.

The temperature range is 30 to 70° C., preferably 45 to 65° C. While the reaction time varies depending on the activity of enzyme used and its amount, it can be usually about 2 minutes to 4 hours, preferably about 5 minutes to 1 hour. When the reaction time is too long, delicious taste, bitter taste and the like are generated.

Therefore, the increase amount of free amino acids by hydrolysis in (c) step is to be kept at 4% by weight or less, preferably 2% by weight or less, and more preferably 1% by weight or less in a dry solid content.

Further, reduction of average molecular weight by hydrolysis in (c) step is to be kept within 50%, preferably within 30%. For example, supposing that average molecular weight of the soybean peptide mixture obtained by separation of insoluble matter after (b) step is 5000, when somewhat hydrolyzed in (c) step and the decrease thereof is within 50%, the average molecular weight is 2500 to 5000, and when within 30%, the average molecular weight is 3500 to 5000.

It is suitable that the enzyme used in this (c) step is an enzyme of the genus Rhizopus or Aspergillus origin.

Examples of the enzyme of the Rhizopus origin include “Peptidase R” (manufactured by Amano Enzyme Inc.) of Rhizopus oryzae origin, “Newlase 3FG” (manufactured by Amano Enzyme Inc.) of Rhizopus niveus origin, and the like.

Examples of the enzyme of the genus Aspergillus origin include “Protease M” “Protease A” (manufactured by Amano Enzyme Inc.), and “Sumizyme AP,” “Sumizyme FP,” “Sumizyme LP,” “Sumizyme LPL,” (manufactured by Shin Nihon Chemicals Co., Ltd.) of Aspergillus oryzae origin, and the like.

Preferably, these enzymes contain an exo-type. Since crude enzymes are usually used, they contain exo- and endo-proteases. Then, the formation of dregs when refrigerated in an acid aqueous system can be suppressed by reacting them under acidic conditions.

That is, when the soybean protein obtained by method A is used, a soybean protein hydrolyzate which hardly forms dregs in an acid aqueous system can be obtained only by (b) step, or by combination of (b) step and (d) step described hereinafter. In this case, (d) step is not necessarily required, but incorporation is preferred.

However, when the soybean protein obtained by method B is hydrolyzed, it is necessary to carry out (b) step, (c) step, and (d) step in combination.

Next, (d) step of the phytic acid-decomposing enzyme treatment will be illustrated.

The pH of the enzymatic decomposition product of soybean protein obtained by the above-described step is usually adjusted to pH 3 to 6.2, preferably pH 4 to 5.5.

Usually, the concentration is similar to that in the hydrolysis of (b) step, and is 1 to 30% by weight, preferably 5 to 15% by weight, and more preferably 8 to 12% by weight. When the treatment is carried out after separation of insoluble matter described hereinafter, the amount of phytic acid-decomposing enzyme to be added can be reduced because the amount of the substrate becomes smaller.

Under acidic conditions, either of (d) step and (c) step can be carried out first, or both can be done at the same time, and (d) step is preferably carried out after (c) step, or at the same time.

First, the phytic acid-decomposing enzyme used in the present invention will be illustrated.

As the phytic acid-decomposing enzyme used in the present invention, its origin is not limited to specific one and there are enzymes of plants such as wheat and potato origin, enzymes of animal organs such as bowel origin, enzymes of microbes such as bacterium, yeast, fungus and actinomycates origin, and gene recombinant enzymes, and it is possible to use enzymes such as a phytase and a phosphatase having a phytic acid-decomposing activity.

Among these phytases and phosphatases which decompose phytic acid, a phytase is more preferable. As the phytase, there can be used that originated from strains capable of producing various kinds of phytases such as the genera Aspergillus, Rhizopus, Saccharomyces, Mucor and Geotrichum. Preferably, that of the genus Aspergillus origin is suitable. More preferably, it can be selected from the group consisting of phytases originated from the genus Aspergillus such as Aspergillus ficuum, Aspergillus niger, and Aspergillus terreus. In order to decompose phytic acid in soybean into inositol, it is necessary to cut an ester group, an enzyme for which is phytase.

Further, as the acidic phosphatase, it is possible to use an acidic phosphatase of fungi origin. Specifically, there can be selected from the group consisting of acidic phosphatases of Aspergillus ficuum origin, Aspergillus niger origin and Aspergillus terreus origin.

Since the decomposition reaction of phytic acid by the enzyme treatment can be carried out under very mild conditions, influence on a protein is very few. For example, the enzyme reaction of the present invention can be carried out at 30 to 70° C. for 0.1 to 30 hours. Preferably, as with the above-mentioned (c) step, it can be treated at 30 to 70° C., usually, for about 0.1 hours to 4 hours, preferably for about 10 minutes to 1 hour.

In general, since a commercially available phytase often contains proteases, when the reaction is carried out for long time, delicious taste sometimes comes out by the activity of proteases.

Additionally, the decomposition reaction of phytic acid can be carried out at pH 3 to 6.2, preferably pH 4 to 5.5 as described above.

Any enzyme can be used regardless of its form such as powder or liquid. The enzyme is added in an amount of 0.01 to 10% by weight, preferably 0.05 to 2% by weight, more preferably about 0.1 to 1% by weight relative to the weight of a crude protein content in a soybean protein. It is preferable to add a phytase whose enzyme potency is 0.1 to 100 U/g crude protein, and preferably 0.5 to 20 U/g crude protein, and more preferably 1 to 10 U/g crude protein. The enzyme activity is quantitatively determined as follows: a reaction mixture containing 0.5 ml of 0.2 M Tris-HCl buffer (pH 6.5) containing 4 mM sodium phytate, 0.4 ml of distilled water and 0.1 ml of an enzyme solution are reacted at 37° C. for 30 minutes, the reaction is ceased by adding 1.0 ml of 10% TCA thereto, and the content of inorganic phosphoric acid in the resulting reaction mixture is measured by Fiske-Subbarow method. The amount of an enzyme that can release 1 μmol of inorganic phosphoric acid in 1 minute under the above-mentioned conditions is defined as 1 unit (U).

In the present invention, it is important to include the steps decomposing a protein using a proteolytic enzyme ((b) step and (c) step) and the step of decomposing phytic acid by a phytic acid-decomposing enzyme ((d) step). Regarding the order of these steps, it is preferable to carry out (b) step first. Preferably, the reaction mixture is adjusted to make it acidic before carrying out (d) step. It is preferable to carry out (d) step after or at the same time of (c) step because the content of phytic acid (mesoinositol hexaphosphate) in the dry solid content of the soybean peptide mixture can be reduced to 0.7% by weight or less, preferably 0.2% by weight or less, more preferably a detection limit or less (detection limit 5 mg/100 g) as determined by vanadomolybdic acid absorption photometry.

Next, (e) step of separating and removing an insoluble matter will be illustrated. The insoluble matter includes an undecomposed residue in the protease treatment of a soybean protein, and it tends to aggregate in the vicinity of the isoelectric point of a soybean protein. In the case where this insoluble matter is present in a solution of the objective soybean peptide mixture, it is required to separate and remove it.

Separation of the insoluble matter is not necessarily required after each step of (b) to (d) steps, but required in any steps after (b) step.

That is, when an insoluble matter is separated and removed after (b) step, separation is not required as long as insoluble matter is not deposited after (c) step or after (d) step. When the treatment of (c) step or (d) step is carried out without removing an insoluble matter after (b) step, the insoluble matter can be removed after (c) step or after (d) step.

As a means for separating and removing an insoluble matter, filtration means such as filter press and membrane separation can be used, and a centrifugal separator, a liquid cyclone or the like can also be used.

The separation of an insoluble matter is suitably carried out at an acidic pH (pH 3 to 6.2).

The pH after the enzyme reaction varies depending on reaction conditions. However, when after (b) step, the pH is usually in a range of pH 5 to 8. Then, in order to separate an insoluble matter, it is suitable to adjust preferably to pH 3 to 6.2, more preferably pH 4 to 5.5. Since the insoluble matter including an undecomposed residue tends to aggregate in the vicinity of the isoelectric point of a soybean protein, in this pH range, aggregating ability of the above-mentioned insoluble matter is enhanced, thereby enhancing separation ability upon separation can be enhanced. This operation is so-called acid precipitation. Since the precipitated protein can be removed by a separation step, this acid precipitation is not problematic. When separation is carried out after (c) step or (d) step, since pH has been already adjusted to acidic, separation can be carried out without pH adjustment.

Further, the above-mentioned aggregating ability of an insoluble matter is also enhanced, thereby enhancing separation ability by adding a chloride of calcium or magnesium; a salt such as a sulfate; an alkaline earth metal compound such as a hydroxide; a protein-aggregating agent such as sodium polyacrylate, alginic acid, chitin or chitosan to a decomposition reaction mixture.

Further, a heat treatment step can be carried out so as to enhance the above-mentioned aggregating ability and separation ability of the insoluble material. This heating may be milder than that for inactivation of an enzyme or sterilization which is generally carried out. The heating can be carried out under conditions that the heating time is 10^{(5.25-0.05×T)} minutes or shorter (wherein T is a heating temperature (° C.)). When the heating time exceeds this, there is such a problem that the decomposed soybean protein hydrolyzate colors, which is not preferable from the view point of quality.

The solution of soybean polypeptide mixture thus obtained can be used as it is or after being concentrated according to particular applications. Alternatively, it can also be subjected to sterilization and drying steps. An apparatus used in the sterilization and drying steps is not specifically limited as long as it is an ordinary sterilization apparatus and, for example, a continuous direct heat sterilization apparatus of steam injection type can be preferably employed. Specifically, the sterilization can be carried out under such conditions that a temperature is 100 to 160° C., preferably 105 to 145° C., and sterilization time is 1 second to 3 minutes.

Further, the drying method is not specifically limited as long as it is a conventionally known drying method and, for example, freeze-dry, spray-dry, vacuum drying, or the like can be preferably employed. Further, before sterilization and drying, various kinds of formulation components can be added and examples thereof include emulsifying components, stabilizing components, nutrient components and sweetener components.

In the case where applications to acidic food and drink such as acidic drink and acidic jelly are intended, average molecular weight of the soybean peptide mixture is 200 to 5000, preferably, 200 to 3000 is suitable.

Further, the content of phytic acid (mesoinositol hexaphosphate) is 0.7% by weight or less in a dry solid content of the soybean peptide mixture, preferably 0.2% by weight or less as determined by vanadomolybdic acid absorption photometry (detection limit 5 mg/100 g). Further, it is suitable that no phytic acid is detected.

As described above, in the case of using the soybean protein of (a), by combination of (b) step, (c) step, and (d) step, and finally by removing an insoluble matter in (e) step, it is possible to obtain a soybean protein hydrolyzate free from dreg formation in an acid aqueous system.

The analytical methods used in the present invention will be illustrated below.

### TCA Soluble Rate

A ratio of 15% trichloroacetic acid (TCA) soluble protein to total protein in a solution prepared by dispersing a protein in water at a concentration of 1.0% by weight and thoroughly stirring is measured by Kjeldahl method, Lowry method or the like.

### Average Molecular Weight

Average molecular weight of a soybean peptide mixture is calculated from molecular weight distribution of the chromatogram obtained by a gel filtration method using high performance liquid chromatography. Specifically, it is carried out as follows.
(1) A soybean peptide mixture is dissolved in an eluent (45% acetonitrile, 0.05% trifluoroacetic acid solution) so that the concentration becomes 0.1% by weight, and filtered with a membrane filter having a pore diameter of 0.2 μm to prepare a test solution.
(2) Chromatogram of the test solution is obtained by the following gel filtration method.
Column: TSK gel G3000PWXL (Tosho Corporation) and TSK gel G2500PWXL (Tosho Corporation), these two in series, flow rate of eluent: 0.3 ml/min, column temperature: 40° C., detection method: absorbance at measuring wavelength of 220 nm.
(3) A molecular weight distribution curve of a sample is prepared by taking holding time in a horizontal axis and taking absorbance values at corresponding 220 nm in a vertical axis to calculate average molecular weight. For data processing of chromatogram, a chromatogram data processing program, JASCO-BORWIN manufactured by JASCO Corporation is used.

### Amount of Free Amino Acids

The amount of free amino acids in a soybean peptide mixture is quantitatively determined in such a manner that the soybean peptide mixture is dispersed in 3% sulfosalicylic acid at a concentration of 0.4% by weight, a peptide component is precipitated and removed, a soluble component is measured using L-8500 model high performance amino acid analyzer manufactured by Hitachi Co., Ltd. The amount of free amino acids in Examples hereinafter represents a content in a dry solid content.

### EXAMPLES

Hereinafter, embodiments of the present invention will be illustrated specifically by Examples. However, the present invention is not limited by these Examples in its technical scope. All percents in Examples are by weight unless otherwise noted.

### Example 1

To 6 parts by weight of warm water at 45° C., 1 part by weight of low-denatured defatted soybean flake of NS190 was slowly added. While being adjusted at pH 4.2 with hydrochloric acid, the mixture was mildly stirred for 10 minutes and washed, the whey component thus eluted was then separated and removed by a centrifugal separator (1500 G, 10 minutes) to obtain of 2 parts by weight of a concentrated soybean protein. To 2 parts by weight of this concentrated soybean protein, 6 parts by weight of warm water at 45° C. was added. After being mildly stirred for 10 minutes and washed, the whey component thus eluted was separated and removed by a centrifugal separator (1500 G, 10 minutes) to obtain 6 parts by weight of whey and 2 parts by weight of a concentrated soybean protein having a water content of 63% and a crude protein amount per solid content of 72%.

To 2 parts by weight of this concentrated soybean protein, 4 parts by weight of water was added, and the mixture was adjusted to pH 7.0, stirred for 30 minutes, and centrifuged to obtain a extraction residue and 4 parts by weight of an extract (solid content 8.0%). The extraction was carried out at 60° C., solid-liquid separation was carried out by centrifugal separation of 1500 G for 10 minutes, pH of the extract was adjusted by using 20% sodium hydroxide solution.

The thus obtained soybean protein extract was sterilized at 140° C. for 10 seconds using a continuous direct heat sterilization apparatus of steam injection type, then spray-dried to prepare a soybean protein isolate powder with a moisture content of 5%. The crude protein amount per dry solid content was 90%.

The thus obtained soybean protein isolate powder was dissolved at 58° C. to prepare a 8% solution of pH 8.5, then, “Protin AY40” (manufactured by Daiwa Kasei Co., Ltd.) as a proteolytic enzyme at an E/S ratio of 1.5% was added, followed by hydrolyzing at 58° C. for 3 hours (15% TCA soluble rate: 70%).

“Protin AY40” is an endo-type alkaline protease.

After citric acid was added to the soybean protein hydrolyzate solution after the enzyme reaction to adjust at pH 4.5, and the mixture was subjected to heat treatment (85° C. over 10 minutes), and then centrifugation (1500 G, 20 minutes) to separate and remove an insoluble matter containing an undecomposed residue. The 15% TGA soluble rate of the hydrolyzate of the centrifuged supernatant obtained was 99%, the average molecular weight was 1200, and the amount of free amino acids was about 0.6%.

To the centrifuged supernatant obtained, a phytic acid-decomposing enzyme “Sumizyme PHY” (manufactured by Shin Nihon Chemicals Co., Ltd.) at an E/S ratio of 0.5% and Rhizopus genus-derived “Peptidase R” (manufactured by Amano Enzyme Inc.) at an E/S ratio of 0.04% were added, and the mixture was reacted at 50° C. for 10 minutes. “Peptidase R” is a neutral peptidase, but contains endo-type and exo-type acidic proteases.

The soybean protein hydrolyzate solution after the enzyme reaction was sterilized at 120° C. for 7 seconds using a continuous direct heat sterilization apparatus of steam injection type, then spray-dried to prepare a soybean peptide mixture powder with a moisture content of 4%.

Regarding the obtained soybean peptide mixture, the 15% TCA soluble rate was 99%, the average molecular weight was 1100, and the amount of free amino acids was about 1%. Further, when the content of phytic acid (mesoinositol hexaphosphate) of this soybean peptide mixture in a dry solid content was measured by vanadomolybdic acid absorption photometry, no phytic acid was detected (detection limit 5 mg/100 g).

### Example 2

According to the same steps as those in Example 1, a soybean peptide mixture powder was prepared except that the addition amount of “Peptidase R” (manufactured by Amano Enzyme Inc.) to be reacted under acidic conditions was changed. Further, in place of this enzyme, each of “Newlase 3FG” (manufactured by Amano Enzyme Inc.) of the genus Rhizopus origin, and “Sumizyme AP” (manufactured by Shin Nihon Chemicals Co., Ltd.), “Sumizyme FP” (manufactured by Shin Nihon Chemicals Co., Ltd.), “Sumizyme LP” (manufactured by Shin Nihon Chemicals Co., Ltd.), “Sumizyme LPL” (manufactured by Shin Nihon Chemicals Co., Ltd.), “Protease M” (manufactured by Amano Enzyme Inc.), and “Protease A” (manufactured by Amano Enzyme Inc.) of the genus Aspergillus origin was alone by varying the addition amount, and a soybean peptide mixture powder was prepared according to the same steps. Each of these enzymes contains endo- and exo-type acidic proteases.

### Measurement of Dregs

The presence of dreg formation of an acidic solution of each of soybean peptide mixtures obtained in the above-mentioned Example 1, Reference Example 1 (described hereinafter), and Comparative Examples 1 to 3 (described hereinafter) by refrigeration was examined by turbidity (OD: Optical Density).

A 5% aqueous solution of each of the soybean peptide mixture powders obtained in Examples 1, 2, Reference Example 1 (described hereinafter), and Comparative Examples 1, 2, 3 (described hereinafter) were prepared, adjusted to pH 3.8 with citric acid, and then cooled to 4° C., and its turbidity (OD₆₁₀ₙₘ) was measured. The results of Example 1, Reference Example 1 and Comparative Examples 1, 2, 3 are shown in Table 1.

TABLE 1

| | OD_{610 nm} |
|---|---|
| Example 1 | 0.013 |
| Reference Example 1 | 0.043 |
| Comparative Example 1 | 1.184 |
| Comparative Example 2 | 1.356 |
| Comparative Example 3 | 1.349 |

In Example 1, OD₆₁₀ₙₘ was 0.013, and dreg formation was suppressed.

Next, the result of the addition amount of each protease in Example 2 and the turbidity when refrigerated is shown in Table 2.

TABLE 2

| | Bacterial | | Added | |
|---|---|---|---|---|
| | strain | | amount | OD_{610 nm} |
| Peptidase | Rhizopus | Made by | 0.01% | 0.796 |
| R | oryzae | Amano | 0.03% | 0.288 |
| | | Enzyme | 0.04% | 0.013 |
| | | Inc. | 0.06% | 0.012 |
| | | | 0.08% | 0.013 |
| | | | 0.10% | 0.021 |
| | | | 0.30% | 0.017 |
| Newlase | Rhizopus | Made by | 0.02% | 0.417 |
| 3FG | niveus | Amano | 0.04% | 0.056 |
| | | Enzyme | 0.06% | 0.022 |
| | | Inc. | 0.08% | 0.023 |
| | | | 0.10% | 0.012 |
| | | | 0.30% | 0.012 |
| Sumizyme | Aspergillus | Made by | 0.01% | 1.088 |
| AP | oryzae | Shin Nihon | 0.03% | 1.049 |
| | | Chemicals | 0.10% | 0.735 |
| | | Co., Ltd. | 0.30% | 0.191 |
| Sumizyme | Aspergillus | Made by | 0.02% | 0.563 |
| FP | oryzae | Shin Nihon | 0.04% | 0.341 |
| | | Chemicals | 0.06% | 0.146 |
| | | Co., Ltd. | 0.08% | 0.081 |
| | | | 0.10% | 0.120 |
| | | | 0.30% | 0.028 |
| Sumizyme | Aspergillus | Made by | 0.04% | 0.369 |
| LP | oryzae | Shin Nihon | 0.06% | 0.342 |
| | | Chemicals | 0.08% | 0.287 |
| | | Co., Ltd. | 0.10% | 0.192 |
| | | | 0.30% | 0.060 |
| Sumizyme | Aspergillus | Made by | 0.30% | 0.084 |
| LPL | oryzae | Shin Nihon | | |
| | | Chemicals | | |
| | | Co., Ltd. | | |
| Protease M | Aspergillus | Made by | 0.30% | 0.017 |
| “Amano” G | oryzae | Amano | | |
| | | Enzyme | | |
| | | Inc. | | |
| Protease A | Aspergillus | Made by | 0.01% | 0.759 |
| “Amano” G | oryzae | Amano | 0.03% | 0.271 |
| | | Enzyme | 0.10% | 0.038 |
| | | Inc. | 0.30% | 0.014 |

As seen from Table 2, the enzymes that no dregs were formed even when refrigerated by reacting under a weak acidic condition (pH 4.5) were “Peptidase R,” and “Newlase 3FG,” of the genus Rhizopus origin, “Sumizyme FP,” “Sumizyme LP,” “Sumizyme LPL,” “Protease M,” and “Protease A” of the genus Aspergillus origin. Although “Sumizyme AP” was not able to prevent dreg formation completely even when 0.3% was added, it was able to reduce the amount of dregs formed.

When a 5% aqueous solution of each of the soybean peptide mixtures obtained in Example 1 and Reference Example 1 described hereinafter was prepared, and the taste was compared, it was found that the one prepared in Example 1 was reduced in unpleasant odors and bad tastes such as astringency as compared with Reference Example 1, and the taste was excellent.

### Comparative Example 1

### Protease Treatment of Soybean Protein by Method A

To 1 part by weight of low-denatured defatted soybean flake (NS190), 12 parts by weight of warm water at 40° C. was added, and the mixture was adjusted to pH 7.0 with sodium hydroxide solution. This soybean dispersion was stirred at 5000 rpm for 1 hour using a homogenizer (manufactured by Tokushu Kikakou Co., Ltd.) and a protein was extracted, and “okara” was removed by a centrifugal separator (1500 G, 10 minutes) to obtain defatted soybean milk. To this defatted soybean milk, hydrochloric acid was added to adjust to pH 4.5, and a protein curd precipitated was recovered by a centrifugal separator. To this protein curd, water was added and the mixture was stirred to prepare curd slurry (DM 9.0%). After pH was adjusted to 7.0, the mixture was sterilized at 140° C. for 10 seconds using a continuous direct heat sterilization apparatus of steam injection type to obtain a soybean protein extract. This was spray-dried to prepare a soybean protein isolate powder with a moisture content of 5%, and then a 8% solution thereof was prepared at 58° C. and pH 8.5.

To the thus obtained soybean protein solution, “Protin AY40” (manufactured by Daiwa Kasei Co., Ltd.) as a proteolytic enzyme at an E/S ratio of 1.5% was added, and the mixture was hydrolyzed at 58° C. for 3 hours (15% TCA soluble rate: 70%). After the enzyme reaction, citric acid was added to the soybean protein hydrolyzate solution to adjust to pH 4.5, and the mixture was subjected to heat treatment (at 85° C. for 10 minutes), and then centrifuged (1500 G, 20 minutes) to separate and remove an insoluble matter containing an undecomposed residue. The resulting soybean protein hydrolyzate solution was sterilized at 120° C. for 7 seconds using a continuous direct heat sterilization apparatus of steam injection type, and then spray-dried to prepare a soybean peptide mixture powder with a moisture content of 4%.

As shown in Table 1, the turbidity (OD₆₁₀ₙₘ) of the solution of this soybean peptide mixture derived from method A was as low as 0.043. Namely, no dregs were formed just only by (b) step (the protease treatment under neutral to alkaline conditions) and (e) step (the separation and elimination of an insoluble matter).

In other words, regarding this soybean peptide mixture, no dregs were formed even under acidic conditions as shown in Table 1 without carrying out the protease treatment under acidic conditions and phytic acid-decomposing enzyme treatment.

### Comparative Example 1

According to the same steps as those in Example 1, a soybean peptide mixture powder was prepared except that “Peptidase R” (manufactured by Amano Enzyme Inc.) to be reacted under acidic conditions was not added.

As shown in Table 1, the turbidity (OD₆₁₀ₙₘ) was as high as 1.184 without the protease treatment under acidic conditions, and dregs were formed.

### Comparative Example 2

According to the same steps as those in Example 1, a soybean peptide mixture powder was prepared except that “Peptidase R” (manufactured by Amano Enzyme Inc.) in the phytase reaction (in acidity) was not added and “Protin AY40” (manufactured by Daiwa Kasei Co., Ltd.) in hydrolysis (pH 6.3 to 8.5) at an E/S ratio of 0.05% was added.

However, OD₆₁₀ₙₘ was 1.356 and the dreg formation was not able to be suppressed even by adding “Peptidase R” (manufactured by Amano Enzyme Inc.) in the hydrolysis of protein under weak alkaline to neutral conditions (pH 6.3 to 8.5).

### Comparative Example 3

According to the same steps as those in Example 1, a soybean peptide mixture powder was prepared except that “Sumizyme PHY” as phytase (manufactured by Shin Nihon Chemicals Co., Ltd.) was not added.

As shown in Table 1, OD₆₁₀ₙₘ was 1.349 and dregs were formed because of no addition of a phytase.

### INDUSTRIAL APPLICABILITY

According to the present invention, it is possible to produce a soybean peptide mixture which has better taste than a conventional soybean peptide mixture and was free from formation of dregs even in an acid aqueous system (particularly pH 3 to 4.5).

From this, even when the soybean peptide mixture is used in food and drink under acidic conditions such as acidic drinks and acidic jellies, the resulting products have good tastes and no dregs are formed. Therefore, the soybean protein mixture can be applied to wide fields of acidic food and drink, in particular, acidic aqueous foods.

While the soybean protein raw material used in the present invention is a soybean protein produced by method B as described in Background Art, it is no need to say that a soybean peptide mixture which does not form dregs in an acid refrigerated aqueous system can be obtained by using a soybean protein produced by method A.

However, in view of a taste, using a soybean protein produced by method B provides a soybean peptide mixture having a better taste than that using a soybean protein raw material obtained by method A.

1. A method for production of a soybean peptide mixture, comprising the steps of: (a) extracting a concentrated soybean protein with water to obtain an extract; (b) treating the extract with a protease under alkaline to neutral conditions; (c) further treating the resulting product with a protease under acidic conditions; (d) treating the resulting product with a phytic acid-decomposing enzyme; and (e) separating and removing an insoluble matter from the product.

2. The method according to claim 1, wherein the enzyme used in (b) step comprises an endo-type.

3. The method according to claim 1, wherein the hydrolysis degree in (b) step is 20 to 98% of a soybean protein decomposition rate in terms of a 15% trichloroacetic acid soluble rate of protein components.

4. The method according to claim 1, wherein the enzyme used in (c) step comprises an exo-type.

5. The method according to claim 1, wherein the enzyme used in (c) step is an enzyme of genus Aspergillus or Rhizopus origin.

6. The method according to claim 1, wherein (d) step is performed after (c) step or simultaneously.

7. The method according to claim 1, wherein average molecular weight of the soybean protein mixture is 200 to 5000.
